(19) United States
(12) Patent Application Publication
(10) Pub. No.: US 2022/0230292 A1
(43) Pub. Date: Jul. 21, 2022

(54) MACHINE LEARNING AND COMPUTER VISION BASED 3D PRINTER MONITORING SYSTEMS AND RELATED METHODS

(71) Applicant: Scott Powers, Carrollton, GA (US)

(72) Inventor: Scott Powers, Carrollton, GA (US)

(21) Appl. No.: 17/579,946

(22) Filed: Jan. 20, 2022

Related U.S. Application Data
(60) Provisional application No. 63/139,377, filed on Jan. 20, 2021.

(51) Int. Cl. G06T 7/00; G05B 19/418; B33Y 50/02

(52) U.S. Cl. CPC G06T 7/001; G05B 19/41875; B33Y 50/02; G06T 2207/20084; G06T 2207/20081; G06T 2207/30144; G05B 2219/32194

(57) ABSTRACT

Machine learning and computer vision based systems and methods for three-dimensional (3D) printer monitoring are described herein. An example method includes receiving an image of an object during a 3D printing process; determining a printing property associated with the object based upon the image of the object; inputting the printing property associated with the object into a machine learning module; and predicting, using the machine learning module, a 3D printing error.

### CROSS-REFERENCE TO RELATED APPLICATIONS

This application claims the benefit of U.S. provisional patent application No. 63/139,377, filed on Jan. 20, 2021, and titled “MACHINE LEARNING AND COMPUTER VISION BASED 3D PRINTER MONITORING SYSTEMS AND RELATED METHODS,” the disclosure of which is expressly incorporated herein by reference in its entirety.

### BACKGROUND

Three-dimensional (3D) Printing is a method of manufacturing in which a physical object is made based on a three-dimensional model (e.g., computer aided design (CAD) model) typically in the form of successive additive layers. 3D Printing differs from subtractive manufacturing in providing the opportunity for rapid prototyping and the accessible production of complex geometrical shapes. 3D Printing is inexpensive compared to its alternatives and requires only a CAD 3D model as a prerequisite. Two types of 3D Printing processes dominate the 3D Printing industry: Fused Deposition Modeling (FDM) and stereolithography (SLA)/selective laser sintering (SLS). FDM printers are characterized by using a continuous supply of a thermoplastic filament which is fed into a heated hotened and deposited on a flat surface while SLA and SLS printers use a laser to cure UV resin or to bond polymer material (3D Hubs, all3DP). FDM printers are the most common 3D Printing method, representing 48% of 3D Printers in 2018 (statista.com). This popularity is due to FDM Printers' inexpensive cost, accessible software/technology, and ease of use compared to other printers. However, the nature of FDM printing, heating and cooling thermoplastics rapidly and depositing it from a moving hotend, results in unpredictable printing defects which threaten efficiency, slow down prototyping efforts, and raise costs. Print quality errors include warping, over extrusion, extrude/hotend clogging, and general deviation from model and often result from hardware failure or incorrect slicer parameters. These errors limit FDM printer's utility as rapid prototyping devices for entrepreneurs or researchers.

### SUMMARY

An example machine learning and computer vision based method for three-dimensional (3D) printer monitoring is described herein. The method includes receiving an image of an object during a 3D printing process; determining a printing property associated with the object based upon the image of the object; inputting the printing property associated with the object into a machine learning model; and predicting, using the machine learning model, a 3D printing error.

In some implementations, the printing property associated with the object is a difference between a moment of a model object in a visual representation of the model object and a moment of the object in the image of the object.

Alternatively or additionally, in some implementations, the printing property associated with the object is a difference between a solidity of a contour of a model object in a visual representation of the model object and a solidity of a contour of the object in the image of the object.

Alternatively or additionally, in some implementations, the printing property associated with the object is a difference between an extent of a contour of a model object in a visual representation of the model object and an extent of a contour of the object in the image of the object.

Optionally, the visual representation of the model object is a rendered model or an image of the model object at a specific point during the 3D printing process.

Alternatively or additionally, the 3D printing error is a surface defect. Alternatively or additionally, the 3D printing error is stringing, warping, extruder failure, or layer shift.

Alternatively or additionally, the machine learning model is a support vector machine (SVM), k-nearest neighbor (KNN) algorithm, random forest (RF), or a neural network.

In some implementations, the method further includes transmitting a notification of the 3D printing error to a user. Optionally, the notification of the 3D printing error includes the image of the object. Alternatively or additionally, the notification includes an audio, video, written or pictorial resource related to the 3D printing error.

In some implementations, the method further includes modifying preparatory code during the 3D printing process in response to predicting the 3D printing error. Optionally, the method further includes transmitting the modified preparatory code to a 3D printer. For example, in some implementations, the modified preparatory code includes a movement command.

Alternatively or additionally, the method optionally further includes generating calibration preparatory code, the calibration preparatory code including one or more movement or extrusion commands that target an error class; receiving the 3D printing error predicted by the machine learning module; and transmitting a notification of the 3D printing error to a user. The notification includes an audio, video, written or pictorial resource related to the 3D printing error.

An example machine learning and computer vision based system for three-dimensional (3D) printer monitoring is described herein. The system includes a three-dimensional (3D) printer; a computing device operably coupled to the 3D printer; a printing property module; and a machine learning module. The computing device includes a processor and a memory operably coupled to the processor. The printing property module is stored in the memory of the computing device and, when executed by the processor, is configured to: receive an image of an object during a 3D printing process, and determine a printing property associated with the object based upon the image of the object. The machine learning module is stored in the memory of the computing device and, when executed by the processor, is configured to: receive the printing property associated with the object, and predict a 3D printing error.

The system optionally further includes an image capturing device operably coupled to the computing device. The image capturing device is configured to capture the image of the object during the 3D printing process.

Alternatively or additionally, the system optionally further includes a calibration module stored in the memory that, when executed by the processor, is configured to: generate calibration preparatory code, the calibration preparatory code including one or more movement or extrusion commands that target an error class; receive the 3D printing error predicted by the machine learning module; and transmit a notification of the 3D printing error to a user. The notification includes an audio, video, written or pictorial resource related to the 3D printing error.

An example calibration method is described herein. The method includes transmitting calibration preparatory code to a three-dimensional (3D) printer, where the calibration preparatory code comprising one or more movement or extrusion commands; monitoring a response of the 3D printer to the calibration preparatory code; inputting the response of the 3D printer to the calibration preparatory code into a machine learning model; and predicting, using the machine learning model, a slicer setting.

Optionally, the method further includes providing a 3D model designed to target a print quality characteristic; printing an object according to the 3D model; and adjusting the slicer setting to improve the print quality characteristic. The print quality characteristic can be one of bridging, overhang, or accuracy performance.

An example calibration system for three-dimensional (3D) printer is described herein. The system includes a three-dimensional (3D) printer; and a computing device operably coupled to the 3D printer. The computing device includes a processor and a memory operably coupled to the processor and is configured to: transmit calibration preparatory code to a three-dimensional (3D) printer, where the calibration preparatory code comprising one or more movement or extrusion commands; monitor a response of the 3D printer to the calibration preparatory code; input the response of the 3D printer to the calibration preparatory code into a machine learning model; and predict, using the machine learning model, a slicer setting.

The systems and methods described herein can mitigate the problems present in conventional 3D Printing as described above, for example by using computer vision to visually detect, classify, and respond to specific error classes. By improving response time to errors less filament and time would be wasted.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a diagram illustrating a system for machine learning and computer vision based 3D printer monitoring according to implementations described herein.

FIG. 2 is a flowchart illustrating example operations for machine learning and computer vision based 3D printer monitoring according to implementations described herein.

FIG. 3 is an example computing device.

FIG. 4 displays the solidity difference between the target output image and the actual print and corresponding layer value from a collection of tests for which the retraction length was set to the default value.

FIG. 5 displays the solidity difference between the target output image and the actual print and corresponding layer value from a collection of tests for which the retraction length was set to a value lower than the default value.

FIG. 6 displays the mean solidity difference for both the tests with the default retraction length and the shortened retraction length, demonstrating a difference in the mean when stringing occurs on the surface of the print.

FIG. 7 shows the difference between the match shapes function (Hu Moments comparison) applied to the target image and the actual print for tests with the default retraction length on the x axis. The corresponding layer is on the y axis.

FIG. 8 shows the difference between the match shapes function (Hu Moments comparison) applied to the target image and the actual print for tests with a shorter retraction length on the x axis. The corresponding layer is on the y axis.

FIG. 9 shows the mean match shapes difference for the shorter retraction length tests and the default length retraction length. This demonstrates that a Hu Moment comparison can be used to identify stringing or similar surface print quality errors.

FIG. 10 shows a visualization of an early SVM model using only the solidity difference and Hu Moments difference data from the initial tests. The data is scaled to the −1 to 1 interval.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

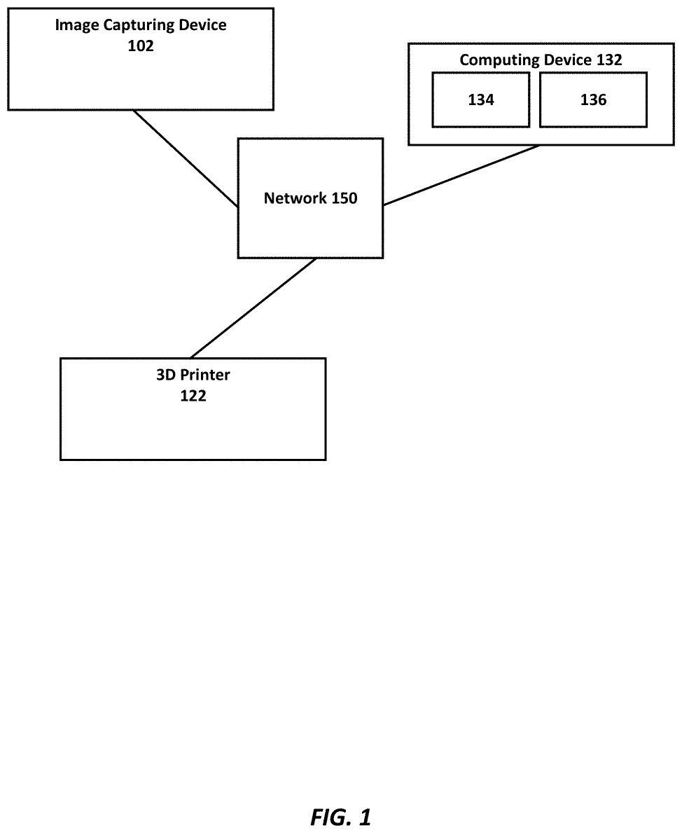

Referring now to FIG. 1, a system for machine learning and computer vision based 3D printer monitoring is described. The system can include an image capturing device 102, a 3D printer 122, and a computing device 132. It should be understood that the system for machine learning and computer vision based 3D printer monitoring described herein may have more or less components and/or having components arranged differently than shown in FIG. 1.

The image capturing device 102, the 3D printer 122, and the computing device 132 are operably coupled to one or more networks 150. This disclosure contemplates that the networks 150 are any suitable communication network. The networks 150 can be similar to each other in one or more respects. Alternatively or additionally, the networks 150 can be different from each other in one or more respects. The networks 150 can include a local area network (LAN), a wireless local area network (WLAN), a wide area network (WAN), a metropolitan area network (MAN), a virtual private network (VPN), etc., including portions or combinations of any of the above networks. Additionally, each of the image capturing device 102, the 3D printer 122, and the computing device 132 are coupled to the one or more networks 150 through one or more communication links. This disclosure contemplates the communication links are any suitable communication link. For example, a communication link may be implemented by any medium that facilitates data exchange including, but not limited to, wired, wireless and optical links. Example communication links include, but are not limited to, a LAN, a WAN, a MAN, Ethernet, the Internet, or any other wired or wireless link such as WiFi, WiMax, 3G, 4G, or 5G.

The image capturing device 102 is configured to capture the image of the object during the 3D printing process. The image can be transmitted from the image capturing device 102 to the computing device 132 of the network 150. This disclosure contemplates that the image can be one or more still images or a video. The image is captured in real-time during the 3D printing process. For example, the image capturing device 102 can be a digital camera. Optionally, in some implementations, the image capturing device 102 can be a webcam such as a Logitech c270 high-definition webcam. Image capturing devices are known in the art and therefore not described in further detail herein. It should be understood that a webcam is provide only as an example image capturing device. This disclosure contemplates using other types of image capturing devices can be used with the systems and methods described herein.

The 3D printer 122 is configured to print the object. It should be understood that the object can be any object that is capable of being produced by successive addition of material (e.g., layer-by-layer). Example objects and printing instructions are available from A113DP of Munich, Germany. In some implementations, the 3D printer 122 is an FDM printer. In other implementations, the 3D printer 122 is an SLA or SLS printer. Optionally, in some implementations, the 3D printer 122 can be a Folger Tech Kossel 2020 Full 3D Printer. 3D printers are known in the art and therefore not described in further detail herein. It should be understood that a Folger Tech Kossel 2020 Full 3D Printer is provided only as an example. This disclosure contemplates using other types of 3D printers with the systems and methods described herein.

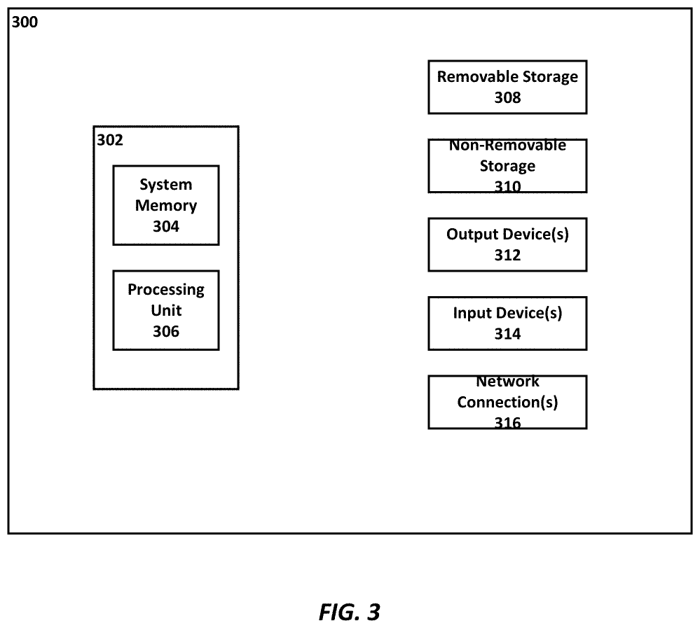

The computing device 132 includes a processor and a memory operably coupled to the processor. This disclosure contemplates that the computing device 132 can be the example computing device as described with regard to FIG. 3. A printing property module 134 is stored in the memory of the computing device 132 and, when executed by the processor, is configured to: receive an image of an object during a 3D printing process, and determine a printing property associated with the object based upon the image of the object. Additionally, a machine learning module 136 is stored in the memory of the computing device 132 and, when executed by the processor, is configured to: receive the printing property associated with the object, and predict a 3D printing error.

Alternatively or additionally, the system optionally further includes a calibration module stored in the memory of the computing device 132 that, when executed by the processor, is configured to: generate calibration preparatory code (e.g., G-code), the calibration G-code including one or more movement or extrusion commands that target an error class; receive the 3D printing error predicted by the machine learning module; and transmit a notification of the 3D printing error to a user. The notification includes an audio, video, written or pictorial resource related to the 3D printing error. Alternatively or additionally, the system may be configured to provide a STL model designed to display print quality issues. Calibration software may also suggest to the user changes to slicer or printer firmware. Such settings include, but are not limited to, retraction speed and length, infill speed, or perimeter speed. A movement command instructs the 3D printer to move the printer head (e.g., direction, speed, etc.). An extrusion command instructs the 3D printer to extrude material (e.g., rate, temperature, etc.).

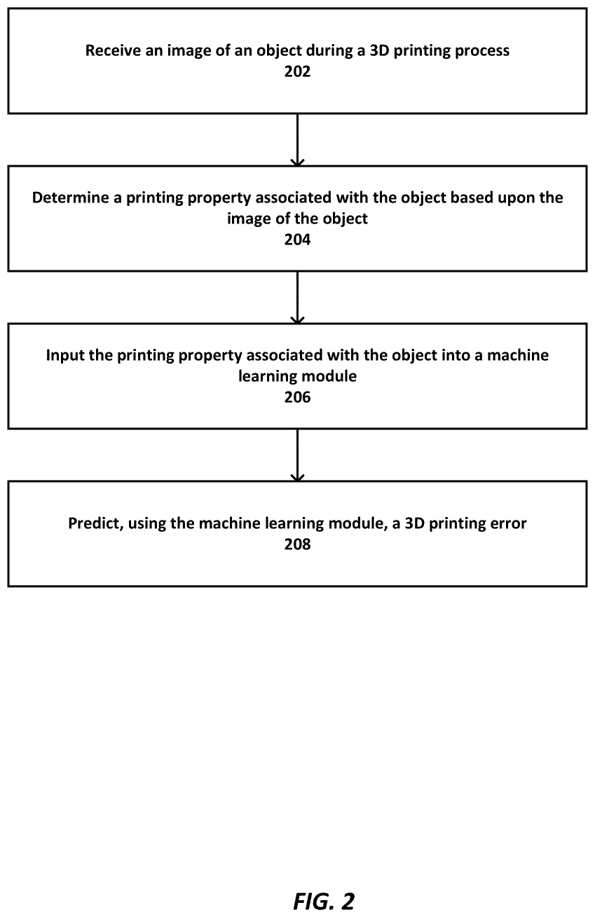

Referring now to FIG. 2, a flowchart illustrating example operations for machine learning and computer vision based 3D printer monitoring are shown. This disclosure contemplates that the methods for machine learning and computer vision based 3D printer monitoring can be performed using the system shown in FIG. 1.

At step 202, an image of an object during a 3D printing process is received. As described herein, the image can be captured using an image capturing device (e.g., image capturing device 102 of FIG. 1) in real time during printing. The image can be captured at any stage of the printing process. Additionally, the image can be received at a computing device (e.g., computing device 132 of FIG. 1) for further analysis as described below. The image is a digital image. For example, the digital image can be of file types including, but not limited to, TIFF, JPEG, GIF, PNG, and RAW image file types. Additionally, it should be understood that a plurality of images can be captured and transferred to the computing device for analysis.

At step 204, a printing property associated with the object is determined based upon the image of the object. For example, this disclosure contemplates that the printing property can be a characteristic (e.g., a physical quantity, measurement, size, shape, etc.) of the object, which is being printed by the 3D printer (e.g., 3D printer 122 of FIG. 1), determined by analyzing the image received at step 202. The printing property can be determined by a computing device (e.g., computing device 132 of FIG. 1). It should be understood that an image received at step 202 captures the object at a point in time during the printing process. As described in detail below, the printing property can optionally be determined by analyzing the image taken at a given point in time and also analyzing a visual representation of the object (e.g., rendered CAD model or another image) at the same point in time. For example, respective characteristics (e.g., a physical quantity, measurement, size, shape, etc.) can optionally be obtained by analyzing the image and the model object and the printing property can be calculated based on these respective characteristics. In some implementations, the printing property is a difference between a moment of a model object in a visual representation of the model object and a moment of the object in the image of the object. In other words, a moment of a model object in a visual representation of the model object (moment A) is calculated (for example by analyzing the model object), and a moment of the object in the image of the object (moment B) is calculated (for example by analyzing the image). As described below, this disclosure contemplates using automated tools such as those available from the OpenCV project, which is an open source computer vision library, to calculate a moment. Thereafter, a difference between the moments (moments A and B) is calculated. Additionally, in some implementations, a set of standard moments of a model object in a visual representation of the model object is compared to a set of standard moments of the object in the image of the object. It should be understood that the sets of standard moments compared to each other are scale and transformation invariant. In some implementations, the visual representation is a rendered model (e.g., a CAD model) at the exact point during the 3D printing process when the image (e.g., image received at step 202) of the object is captured. Optionally, the model is rendered in real time during the printing process. In other implementations, the visual representation is an image of the model object at the exact point during the 3D printing process when the image (e.g., image received at step 202) of the object is captured. For example, this disclosure contemplates that there may be an image repository with images of the object taken at various points in time during the printing process. It should be understood that the difference between the expected (e.g., moment A) and actual (e.g., moment B) moments provides an indication of print quality and/or accuracy. If the difference is too large, then there is a printing error. This disclosure contemplates comparing the difference to a threshold. It should be understood that the value of the threshold can be chosen to represent a desired print quality and/or accuracy. Additionally, the threshold value depends on the printing property, the type of object being printed, printing material, printing specifications, and/or quality controls. The value of the difference relative to the threshold can be used to flag a printing error. Optionally, the moment is a Hu moment. Hu moments (or Hu moment invariants) are calculations using central moments of an object that are invariant to image transformations (e.g., translation, rotation and scale). This disclosure contemplates that the matchShapes function from the OpenCV project, which is an open source computer vision library, can be used to determine the moments. Hu moments are known in the art and therefore not described in further detail herein. It should be understood that Hu moments are provided only as an example and that other moments can be used. Additionally, it should be understood that the matchShapes function from the OpenCV project is provided only as an example and that other functions, tools, or techniques can be used to determine the moment.

Alternatively or additionally, in some implementations, the printing property is a difference between a solidity of a contour of a model object in a visual representation of the model object and a solidity of a contour of the object in the image of the object. It should be understood that solidity is the area of an object divided by its convex hull. Solidity is an object ratio well known in the art and therefore not described in further detail herein. In other words, a solidity of a contour of a model object in a visual representation of the model object (solidity A) is calculated (for example by analyzing the model object), and a solidity of a contour of the object in the image of the object (solidity B) is calculated (for example by analyzing the image). As described below, this disclosure contemplates using automated tools such as those available from the OpenCV project, which is an open source computer vision library, to calculate a solidity of contour. Thereafter, a difference between the solidity of contours (solidity A and B) is calculated. As discussed herein, the visual representation can be a rendered model (e.g., a CAD model) or image of the model object at the exact point during the 3D printing process when the image (e.g., image received at step 202) of the object is captured. It should be understood that the difference between the expected (e.g., solidity A) and actual (e.g., solidity B) solidity of contours provides an indication of print quality and/or accuracy. If the difference is too large, then there is a printing error. As described herein, this disclosure contemplates comparing the difference to a threshold to flag a printing error. This disclosure contemplates that the contour properties tool from the OpenCV project, which is an open source computer vision library, can be used to determine the solidity of contour. It should be understood that the contour properties tool from the OpenCV project is provided only as an example and that other functions, tools, or techniques can be used to determine the solidity of contour.

Alternatively or additionally, in some implementations, the printing property is a difference between an extent of a contour of a model object in a visual representation of the model object and an extent of a contour of the object in the image of the object. It should be understood that extent is the area of an object divided by an area of its bounding rectangle. Extent is an object ratio well known in the art and therefore not described in further detail herein. In other words, an extent of a contour of a model object in a visual representation of the model object (extent A) is calculated (for example by analyzing the model object), and an extent of a contour of the object in the image of the object (extent B) is calculated (for example by analyzing the image). As described below, this disclosure contemplates using automated tools such as those available from the OpenCV project, which is an open source computer vision library, to calculate an extent of contour. Thereafter, a difference between the extent of contours (extent A and B) is calculated. As discussed herein, the visual representation can be a rendered model (e.g., a CAD model) or image of the model object at the exact point during the 3D printing process when the image (e.g., image received at step 202) of the object is captured. It should be understood that the difference between the expected (e.g., extent A) and actual (e.g., extent B) extent of contours provides an indication of print quality and/or accuracy. If the difference is too large, then there is a printing error. As described herein, this disclosure contemplates comparing the difference to a threshold to flag a printing error. This disclosure contemplates that the contour properties tool from the OpenCV project, which is an open source computer vision library, can be used to determine the extent of contour. It should be understood that the contour properties tool from the OpenCV project is provided only as an example and that other functions, tools, or techniques can be used to determine the solidity of contour. Additionally, it should be understood that moments, solidity of contour, and extent of contour are provided only as example printing properties associated with the object. This disclosure contemplates using other printing properties associated with the object with the systems and methods described herein.

At step 206, the printing property associated with the object is input into a machine learning model. It should be understood that the machine learning model can be a trained machine learning model. A trained machine learning model has undergone a training process with a data set (e.g., a labeled data set for supervised learning) such that its node weights, biases, etc. are tuned, and the model is therefore ready to function in inference mode, i.e., the model is configured to predict a target (e.g., printing error/no printing error) based on a one or more input features (e.g., a difference between moments, solidity of contour, extent of contour, or combinations thereof). In some implementations, the model feature (e.g., input) is a single printing property such as the difference between moments described above. In other implementation, the model feature (e.g., input) is the difference between solidity of contours described above. In yet other implementations, the model feature (e.g., input) is the difference between extent of contours described above. Alternatively, in other implementations, the model features (e.g., input) include multiple printing properties such as two or more of the differences between moments, differences between solidity of contours, and differences between extent of contours properties described above. The printing property (or multiple printing properties) becomes the input (e.g., the feature data set) to a machine learning model. The feature data set is therefore the data which is analyzed by a trained machine learning model operating in inference mode to make a prediction (also referred to as “target” or “targets” of the machine learning model). As described below, the target of the machine learning model is the 3D printing error. This disclosure contemplates that the machine learning model can be selected, trained, and tested with a large training data set containing printing properties associated with the object and printing errors using training methods known in the art. Once trained, the machine learning model can be used in inference mode to make predictions based on new data.

The machine learning model can be a supervised learning model, semi-supervised learning model, or unsupervised learning model. In a supervised learning model, the model learns a function that maps an input (also known as feature or features) to an output (also known as target or target) during training with a labeled data set (or dataset). In an unsupervised learning model, the model learns a function that maps an input (also known as feature or features) to an output (also known as target or target) during training with an unlabeled data set. In a semi-supervised model, the model learns a function that maps an input (also known as feature or features) to an output (also known as target or target) during training with both labeled and unlabeled data.

For example, in some implementations, the machine learning model is an artificial neural network. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can optionally be arranged in a plurality of layers such as input layer, output layer, and one or more hidden layers. Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement n activation function (e.g., binary step, linear, sigmoid, tanH, or rectified linear unit (ReLU) function), and provide an output in accordance with the activation function. Additionally, each node is associated with a respective weight. ANNs are trained with a data set to minimize the cost function, which is a measure of the ANN's performance. Training algorithms include, but are not limited to, backpropagation. The training algorithm tunes the node weights and/or bias to minimize the cost function. It should be understood that any algorithm that finds the minimum of the cost function can be used to for training the ANN. It should be understood that an ANN is provided only as an example and that the machine learning model can be a support vector machine (SVM), k-nearest neighbor (KNN) algorithm, random forest (RF), or other machine learning model.

At step 208, a 3D printing error is predicted using the machine learning model. It should be understood that the machine learning model can be trained to predict 3D printing errors (e.g., the target). In some implementations, the 3D printing error is a surface defect. Alternatively or additionally, in other implementations, the 3D printing error is stringing. Alternatively or additionally, in other implementations, the 3D printing error is warping. Alternatively or additionally, in other implementations, the 3D printing error is extruder failure. Alternatively or additionally, in other implementations, the 3D printing error is layer shift. It should be understood that surface defects, stringing, warping, extruder failure, and layer shift are provided only as examples. This disclosure contemplates that the 3D printing error can be other types of errors including, but not limited to, over extrusion, overheating, and curling.

Optionally, a notification of the 3D printing error can be transmitted to a user. The notification can be determined by a computing device (e.g., computing device 132 of FIG. 1). In some implementations, the notification of the 3D printing error includes the image of the object. Alternatively or additionally, in some implementations, the notification includes an audio, video, written or pictorial resource related to the 3D printing error. This may include instructions and/or links to materials for fixing the 3D printing error.

Optionally, preparatory codes can be modified during the 3D printing process in response to predicting the 3D printing error and then transmitted to the 3D printer. This can occur in real time during the printing process. The modification can be made by a computing device (e.g., computing device 132 of FIG. 1). For example, the modification can be made by slicing software (also referred to as the “slicer”), which is used to convert a 3D model object (e.g., .STL file) into specific instructions for the 3D printer. For example, Slic3r is open source slicing software for 3D printing. As used herein, preparatory code is any instruction in a computer numerical control (CNC) programming language. Preparatory codes are used to control computerized machine tools such as 3D printers. G-code (geometric code) is an example CNC programming language used by 3D printers. It should be understood that G-code is provided only as an example and that other programming languages can be used. Optionally, the modified preparatory code (e.g., G-code) can be a movement command parameter such as a retraction length, retraction speed, bridging speed, perimeter speed, and/or layer height. Conventionally, 3D printer control programs do not allow a user to change movement command parameters such as retraction length, retraction speed, and/or layer height without pausing the printing process. These are instead set by the user before slicing the 3D model object (e.g., .STL file) to produce the G-code. In contrast, the preparatory code described herein can include real-time modifications to such movement command parameters in order to address or resolve the 3D printing error.

For example, a user can initiate a printing process to print an object using a 3D printer (e.g., 3D printer 122 of FIG. 1). During the printing process, a machine learning and computer vision based 3D printer monitoring process as described with regard to FIG. 2 can be employed to flag 3D printing errors. At a given point in time during the printing process, an image of the object is captured and received by a computing device (e.g., computing device 132 of FIG. 1). Thereafter, a printing property associated with the object is determined by the computing device. Optionally, as described above, the printing property may be a difference between a Hu moment of a virtual representation of the object (e.g., rendered CAD model) at the given point in time and a Hu moment of the object captured in the image at the given point in time. As described above, printing properties are not limited to Hu moments and can be other properties including, but not limited to, solidity of contour and extend of contour. Thereafter, the printing property is input by the computing device into a trained machine learning model, which is configured to predict 3D print errors. Thereafter, the machine learning model predicts a 3D printing error. Thereafter, and in response to the predicted error, preparatory codes are modified during the 3D printing process (i.e., in real time). The modified preparatory code (e.g., G-code) may be a movement command parameter such as a retraction length, retraction speed, bridging speed, perimeter speed, and/or layer height. The modified preparatory code is then transmitted to the 3D printer. The process above is executed in real time and without pausing the printing process.

This disclosure also contemplates that the systems and methods described herein can be used during 3D printer calibration. For example, preparatory code (e.g., G-code) for calibration can be generated, where such G-code includes one or more movement or extrusion commands that target an error class. Calibration may be run by a user after assembly to discover optimal settings (e.g., setting for slicer and firmware) for each printer. Upon receipt of the 3D printing error predicted by the machine learning module, a notification of the 3D printing error can be transmitted to a user. As described herein, the notification can include an audio, video, written or pictorial resource related to the potential 3D printing error or troubleshooting suggestions for hardware modifications.

Systems and methods for 3D printer calibration are also described herein. An example method can include generating calibration preparatory code for the 3D printer. The calibration preparatory code can include, but is not limited to, target movement commands and/or target extrusion commands. As described herein, preparatory codes such as G-code are instructions used to control computerized machine tools such as 3D printers. Additionally, as described herein, a movement command instructs the 3D printer to move the printer head (e.g., direction, speed, etc.), and an extrusion command instructs the 3D printer to extrude material (e.g., rate, temperature, etc.). The method can also include transmitting the calibration preparatory code and monitoring a response of the 3D printer to the calibration preparatory code. In some implementations, the monitored response can be real-time images of the object during the printing process as described herein. Alternatively or additionally, the monitored response can be feedback measured by one or more sensors, e.g., sensors tracking movement of the printer head and/or temperature or flow sensors monitoring extrusion properties. Additionally, the calibration method may include providing a 3D model (e.g., an STL or GCode 3D Model) designed as to test bridging, overhang, and accuracy performance. The user is prompted to remove the object after the print is finished in order to complete more prints, each time making small adjustments to slicer settings until acceptable quality is reached. If the system is unable to reach acceptable quality, resources can be provided to the user to troubleshoot hardware issues. This is in contrast to conventional calibration systems, where a user guesses initial settings without achieving optimal quality. Optionally, the calibration system can be used to address common assembly issues of a 3D printer kit.

The method can further include inputting the response of the 3D printer to the calibration preparatory code into a machine learning model, and predicting, using the machine learning model, one or more slicer settings. Optionally, in some implementations, the predicted slicer setting is an optimal slicer setting for the specific 3D printer configuration. The slicer setting can then be modified accordingly. In other words, the response of the 3D printer to the calibration preparatory code becomes the input to the machine learning model (e.g., feature data set). The feature data set is therefore the data which is analyzed by a trained machine learning model operating in inference mode to make a prediction (also referred to as “target” or “targets” of the machine learning model). The feature data set may include only data from printers similar to the printer being considered for calibration. The target of the machine learning model is one or more slicer settings. This disclosure contemplates that the machine learning model can be selected, trained, and tested with a large training data set related to calibration using training methods known in the art. Once trained, the machine learning model can be used in inference mode to make predictions based on new data. This disclosure contemplates that the machine learning model can be a supervised learning model, semi-supervised learning model, or unsupervised learning model. For example, in some implementations, the machine learning model is an artificial neural network.

Referring to FIG. 3, an example computing device 300 upon which the methods described herein may be implemented is illustrated. It should be understood that the example computing device 300 is only one example of a suitable computing environment upon which the methods described herein may be implemented. Optionally, the computing device 300 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 300 typically includes at least one processing unit 306 and system memory 304. Depending on the exact configuration and type of computing device, system memory 304 may be volatile (such as random access memory (RAM)), non-volatile (such as read-only memory (ROM), flash memory, etc.), or some combination of the two. This most basic configuration is illustrated in FIG. 3 by dashed line 302. The processing unit 306 may be a standard programmable processor that performs arithmetic and logic operations necessary for operation of the computing device 300. The computing device 300 may also include a bus or other communication mechanism for communicating information among various components of the computing device 300.

Computing device 300 may have additional features/functionality. For example, computing device 300 may include additional storage such as removable storage 308 and non-removable storage 310 including, but not limited to, magnetic or optical disks or tapes. Computing device 300 may also contain network connection(s) 316 that allow the device to communicate with other devices. Computing device 300 may also have input device(s) 314 such as a keyboard, mouse, touch screen, etc. Output device(s) 312 such as a display, speakers, printer, etc. may also be included. The additional devices may be connected to the bus in order to facilitate communication of data among the components of the computing device 300. All these devices are well known in the art and need not be discussed at length here.

The processing unit 306 may be configured to execute program code encoded in tangible, computer-readable media. Tangible, computer-readable media refers to any media that is capable of providing data that causes the computing device 300 (i.e., a machine) to operate in a particular fashion. Various computer-readable media may be utilized to provide instructions to the processing unit 306 for execution. Example tangible, computer-readable media may include, but is not limited to, volatile media, non-volatile media, removable media and non-removable media implemented in any method or technology for storage of information such as computer readable instructions, data structures, program modules or other data. System memory 304, removable storage 308, and non-removable storage 310 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 306 may execute program code stored in the system memory 304. For example, the bus may carry data to the system memory 304, from which the processing unit 306 receives and executes instructions. The data received by the system memory 304 may optionally be stored on the removable storage 308 or the non-removable storage 310 before or after execution by the processing unit 306.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Materials

Folger Tech Kossel 2020 Full 3D Printer

Hatchbox PLA Filament 1.75 mm

Webcam—Logitech C270

Spinel 2MP Full HD Ultra Low Light USB Camera Module

iPhone Adjustable Brightness Flashlight

Python Interpreter, OpenCV, etc.

Webcam Tripod and Adapter

### Procedure

This project uses four distinct methods of detection, each specific to the error class they address. The project and accompanying programs were written in Python and utilize the packages: OpenCV, Keras, NumPy, and scikit-learn among others. For the detection of surface errors feature matching (SIFT, SURF) was proposed but determined to be insufficient due to the limited number of features on functional 3D printed objects. SIFT and SURF are example feature matching algorithms known in the art, for example, as described in U.S. Pat. No. 6,711,293 to Lowe, titled “Method and apparatus for identifying scale invariant features in an image and use of same for locating an object in an image,” and U.S. Pat. No. 8,165,401 to Funayama et al., titled “Robust interest point detector and descriptor.” Several methods for tracking the extruder body were tested including tracking an individual point optical flow using the Lucas-Kanade method and single object trackers such as the Boosting Tracker, MIL Tracker, and others (see FIG. 4). Ultimately the Boosting tracker object tracker was found to be the most consistent along with updating the tracker region of interest every thirty seconds. All implementations of the extruder fail detection utilize Hough Transform to discover the expected position of the nozzle based on a visual marker in the form of a white circle on a black background. The program periodically resets the tracking ROI based on a new Hough Transform operation and its resulting center to prevent the tracking ROI from drifting as was the case in initial tests. To determine an extruder failure, the program gathers the difference between the y value of the nozzle position and the y value of the top point of the object. If this difference consistently surpasses a threshold set by the user, warnings are triggered, logged in a text file, and can optionally send an email warning the user with error information. Once the tracking method was determined through test prints, the program was run four times when the filament was cut and two times when the filament was not cut. Next, stringing was tested using properties of the largest contour in the mask of the filament HSV range selected by the user. A corresponding rendering or image is gathered in order to compare the current contour to a contour of the object without stringing or other surface errors. The contours are compared according to their Hu moments (which are rotation, scale, and transformation invariant) and their solidity measure (OpenCv Docs). The program was performed nine times with two tests testing solely for false positives. The dataset (solidity difference and hu moment difference values) generated can be analyzed to generate a policy with an SVM or KNN algorithm for recognizing stringing or other surface errors. Finally, shifting of a set of layers, due to a temporary impediment to the movement of the hotend, was detected by monitoring drastic short term changes in the leftmost extreme contour point and the rightmost extreme point. This program will be tested by its detection of a shift when a printed cylinder is automatically knocked leftward by the hotend body using a sequence of G-code following the prints completing. Warping may be approached using a CNN image classifier.

### Data Analysis

The Lucas Kanade optical flow tracking lacked long term consistency and the other Tracking APIs tested struggled at high XY print head speeds while the Boosting tracker was found to be consistent in tracking throughout prints. The extruder failure implementation was found to be very accurate with few false positives after a robust policy was implemented. Through experimentation, it was discovered that the Boosting Tracker API combined with an update to the bounding box every two minutes was the best tracking method. The tests for shifting testing demonstrated that the extreme points of the contour can be used to detect detachment from the bed or shifting layers. This disclosure contemplates using a learning technique based on features to determine the proper shift distance that threatens the print. The data from the stringing recognition test demonstrates a clear difference in the comparison value between retracting enabled and retracting off profiles. However, the program also at times gets outliers for greater than 10 for the comparison metric that could be caused by the failure to detect the contour or detecting the contour of the hotend as well. This disclosure contemplates that the program would likely get better results if data was collected at more intervals and on a larger scaled object and stored as a median of a list of points. The tests in which the printed object was scaled up receive more consistent results due to more easily detectable contours. The data for the stringing tests proved the possibility of developing a policy to respond to Stringing error in 3D Printing. An SVM model was later used to develop a method of classification of stringing and non stringing prints using sklearn and python. This allows for possible online learning and improvement of the system over time when more data from errors and successful prints are logged.

### Results

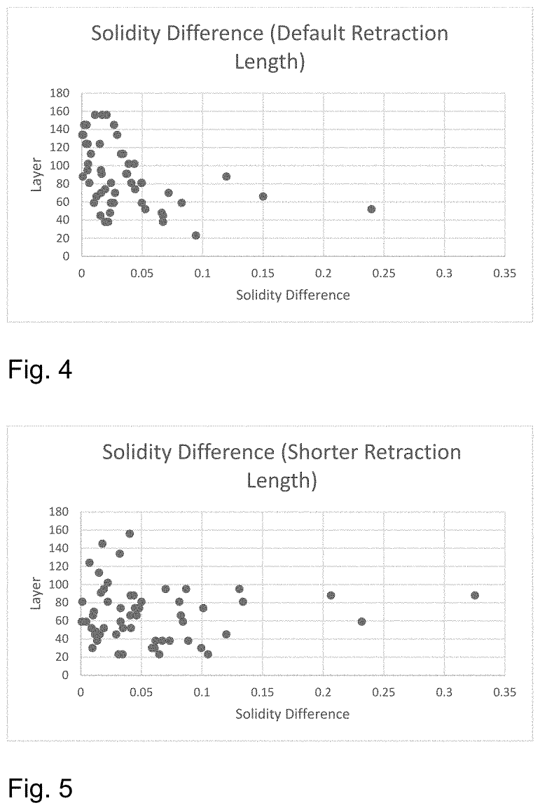

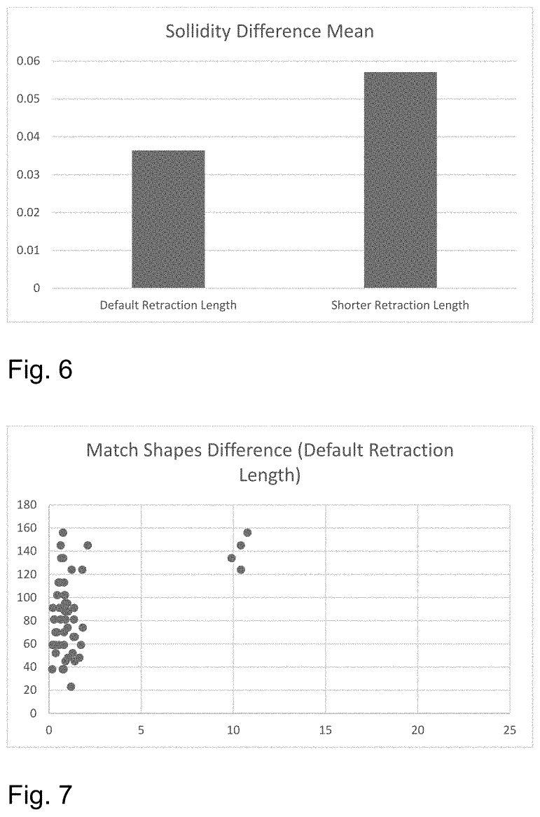

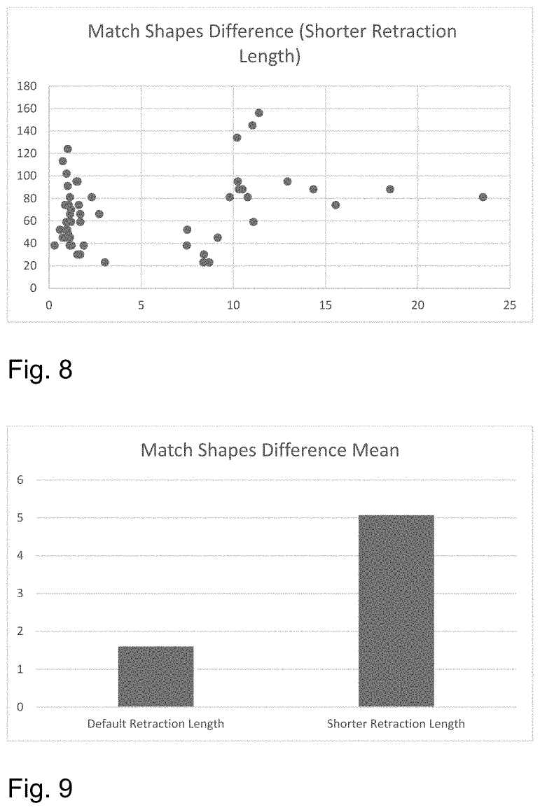

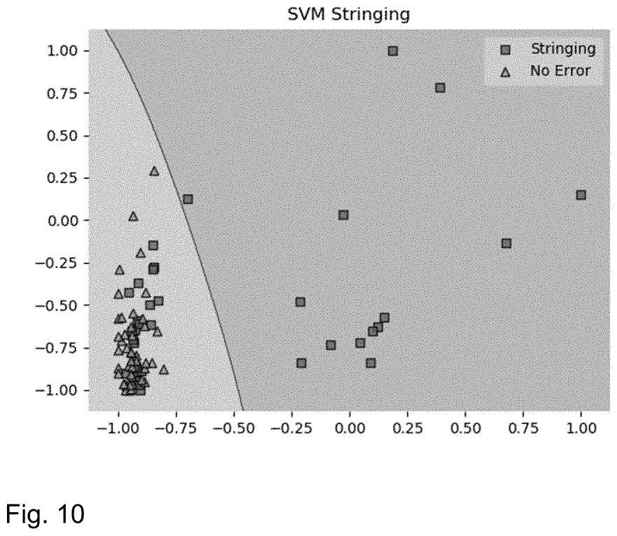

Results are shown in FIGS. 4-10 and below.

Default Retraction Length: Mean Solidity Difference=0.0363943, and Mean Match Shapes Difference=1.6000093.

Shorter Retraction Length: Mean Solidity Difference=0.057097, and Mean Match Shapes Difference=5.070328.

### Conclusion

This example confirms that all error classes chosen were able to be detected reliably. The figures above demonstrate the difference in the Match Shapes and solidity comparison for a print with an acceptable retraction length and one with a short retraction length can be used to identify an unsuccessful print. This disclosure contemplates that the method can be improved by large scale study and/or lighting, which was constrained due to the fixed position of the webcam in the current setup. The image segmentation and contour identification are reliant on the print bed color being outside the HSV segmentation range of the filament. Also, the distance algorithm lacks scalability as the static position of the webcam limits the size of prints as the relationship between the print head and the printed object is distorted as the perspective changes. A printer using this error detection method may require specific design considerations in order for the camera field of view to capture large or wide prints and for lighting and background colors to allow for image segmentation and identification of the printed object. Optionally, the user may enter the color of the filament for identification. The detection of contours is often dependent on lighting strength and position and can require a contrasting background to distinguish small contour features such as stringing. An alternative to the image segmentation and contour analysis approach to detect is training a neural network on images of classes of surface-based errors such as poor bridging, stringing, warping, visual delamination, and over/under extrusion. The limiting factor to this approach would be an ample dataset. This disclosure also contemplates providing a graphical user interface (GUI) application that can detect all error classes simultaneously and respond in real-time with g code commands. The GUI can start a print after receiving an inputted the HSV color range and print G-code directly. The GUI can also allow for configuration of the matching methods and viewing of the object with labels detailing the data the program was receiving to enhance user understanding of the scene. To develop a more robust detection system, CNNs can be used and trained on images of surface errors and warping. This allows the program to be less responsive to changes in lighting, glare, and scale. A camera can also be mounted to the hotend body to examine the top perimeter and infill structure of the print throughout the print and compare it to an image or rendering. Optionally, a camera on rails system can be incorporated into the printer frame to adjust for the prospective issue of the static camera.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
receiving an image of an object during a three-dimensional (3D) printing process;
determining a printing property associated with the object based upon the image of the object;
inputting the printing property associated with the object into a machine learning model; and
predicting, using the machine learning model, a 3D printing error.

2. The method of claim 1, wherein: the printing property associated with the object is a difference between a moment of a model object in a visual representation of the model object and a moment of the object in the image of the object, the printing property associated with the object is a difference between a solidity of a contour of a model object in a visual representation of the model object and a solidity of a contour of the object in the image of the object, or the printing property associated with the object is a difference between an extent of a contour of a model object in a visual representation of the model object and an extent of a contour of the object in the image of the object.

3. (canceled)

4. (canceled)

5. The method of claim 2, wherein the visual representation of the model object is a rendered model or an image of the model object at a specific point during the 3D printing process.

6. The method of claim 1, wherein the 3D printing error is a surface defect, stringing, warping, extruder failure, or layer shift.

7. (canceled)

8. The method of claim 1, wherein the machine learning model is a support vector machine (SVM), k-nearest neighbor (KNN) algorithm, random forest (RF), or a neural network.

9. The method of claim 1, further comprising transmitting a notification of the 3D printing error to a user.

10. The method of claim 9, wherein the notification of the 3D printing error comprises the image of the object.

11. The method of claim 9, wherein the notification comprises an audio, video, written or pictorial resource related to the 3D printing error.

12. The method of claim 1, further comprising modifying a preparatory code during the 3D printing process in response to predicting the 3D printing error.

13. The method of claim 12, further comprising transmitting the modified preparatory code to a 3D printer.

14. The method of claim 12, wherein the modified preparatory code comprises a movement command.

15. The method of claim 1, further comprising:
generating calibration preparatory code, the calibration preparatory code comprising one or more movement or extrusion commands that target an error class;
receiving the 3D printing error predicted by the machine learning module; and
transmitting a notification of the 3D printing error to a user, wherein the notification comprises an audio, video, written or pictorial resource related to the 3D printing error.

16. A system, comprising:
a three-dimensional (3D) printer;
a computing device operably coupled to the 3D printer, the computing device comprising a processor and a memory operably coupled to the processor, the memory having computer-executable instructions stored thereon;
a printing property module stored in the memory that, when executed by the processor, is configured to:
receive an image of an object during a 3D printing process, and
determine a printing property associated with the object based upon the image of the object; and
a machine learning module configured to:
receive the printing property associated with the object, and predict a 3D printing error.

17. The system of claim 16, further comprising an image capturing device operably coupled to the computing device, the image capturing device being configured to capture the image of the object during the 3D printing process.

18. The system of claim 16, further comprising a calibration module stored in the memory that, when executed by the processor, is configured to:
generate calibration preparatory code, the calibration preparatory code comprising one or more movement or extrusion commands that target an error class;
receive the 3D printing error predicted by the machine learning module; and
transmit a notification of the 3D printing error to a user, wherein the notification comprises an audio, video, written or pictorial resource related to the 3D printing error.

19. The system of claim 16, wherein: the printing property associated with the object is a difference between a moment of a model object in a visual representation of the model object and a moment of the object in the image of the object, the printing property associated with the object is a difference between a solidity of a contour of a model object in a visual representation of the model object and a solidity of a contour of the object in the image of the object, or the printing property associated with the object is a difference between an extent of a contour of a model object in a visual representation of the model object and an extent of a contour of the object in the image of the object.

20. (canceled)

21. (canceled)

22. (canceled)

23. The system of claim 16, wherein the 3D printing error is a surface defect, stringing, warping, extruder failure, or layer shift.

24. (canceled)

25. The system of claim 16, wherein the machine learning module is a support vector machine (SVM), k-nearest neighbor (KNN) algorithm, random forest (RF), or a neural network.

26. The system of claim 16, further comprising transmitting a notification of the 3D printing error to a user.

27. (canceled)

28. (canceled)

29. The system of claim 16, wherein the printing property module is, when executed by the processor, further configured to modify preparatory code during the 3D printing process in response to predicting the 3D printing error.

30-37. (canceled)
